(19) United States
(12) Patent Application Publication
(10) Pub. No.: US 2007/0066367 A1
(43) Pub. Date: Mar. 22, 2007

(54) Method and arrangement for repairing memory chips using microlithography methods

(76) Inventors: Jochen Kallscheuer, Munchen (DE); Bernhard Ruf, Taufkirchen (DE); Reinhard Salchner, Haar (DE); Helmut Schneider, Wartenberg (DE)

Correspondence Address: JENKINS, WILSON, TAYLOR & HUNT, P. A., 3100 TOWER BLVD, SUITE 1200, DURHAM, NC, 27707, US

(21) Appl. No.: 10/987,720

(22) Filed: Nov. 12, 2004

(30) Foreign Application Priority Data
Nov. 19, 2003 (DE) 10354112.8

(51) Int. Cl. A01D 75/18; G03C 5/00; A01F 12/16; A01F 21/00

(52) U.S. Cl. 460/5; 430/323

(57) ABSTRACT

The present invention relates to methods for repairing memory chips (7) with redundant cell areas and fuses using microlithography means, characterized by the following method steps: a) photoresist is applied to at least one wafer (6) which is to be repaired; b) a mask (1) is created in line with the chip-specific fuse coordinates; and c) at least one wafer (6) provided with photoresist is exposed using an exposure means through the mask (1); and an arrangement for a method for repairing memory chips (7) with redundant cell areas and fuses using microlithography means, where the arrangement comprises an application unit for photoresist onto wafers (6) which are to be repaired, a controllable mask (1) and an exposure means (2).

The invention relates to a method for repairing memory chips with redundant cell areas and fuses using microlithography means and to an arrangement for such a method.

All memory chips (DRAM, SDRAM, CHIP, SDR, DDR, . . .) produced have their function checked. Almost 100% of these memory chips need to be repaired after the first wafer test (prefuse test), in order to achieve their full functionality. The success of the repair needs to be checked in a second wafer test (postfuse test). The repair itself is performed by replacing the faulty memory cells located during the prefuse test with functioning redundant cells which have already been put on the chip for this purpose. To control this repair process, certain electrical circuits need to be connected on the chip. This is done by breaking interconnects (fuses), which disconnects the fault points, on the one hand, and switches in the redundant cell areas, on the other. The fuses, which are accommodated in blocks in “fuse banks”, are blown using a powerful laser beam (laser fuses) in order to break them. Since only very specific fuses among the total of up to several 1000 fuses (dependent on the product) need to be broken in line with the chip-specific fault picture, the prefuse test uses a computation process to provide the laser process with the necessary fuse coordinates (redundancy analyzer, fuse coordinates converter).

Laser repair has the following drawbacks inside of production. The dimensions of the laser machines means that setting up the latter in the clean room takes up a considerable amount of surface area (approximately 100 m²) and represents a great cost factor. By way of example, a class 100 clean room and a particular infrastructure are required for the laser repair machines. In addition, the purchase costs for a laser machine, at currently approximately 2 to 3 million dollars, are considerable. Other drawbacks are a time factor and maintenance. It is also only ever possible to repair a single chip simultaneously per machine. The fuse times per chip have risen continuously in recent years, for example 10 seconds, as a result of the ever increasing redundancy and associated rising number of fuses. The fuse process can represent a bottle neck in production. In addition, the laser machine needs to be loaded with a new setup and retested whenever there is a product change.

Since the fuse process is limited to one particular feature size, the fuses or the fuse banks need to have a particular size which far exceeds the features of modern chips (90 nm) and takes up an ever increasing percentage of the total area of the chip.

Designs of “electrical fuses” are also known which are “melted” using a large current. This method has not been able to be implemented productively to date, however.

In addition, it has been possible to keep down the size of the fuse banks in particular limits by arranging the individual fuses with an offset. However, this also did not allow the proportion of surface area to be reduced decisively. In addition, this disadvantageously results in long distances which the fuse machine needs to cover in order to control the laser beam from one fuse to the next. This disadvantageously results in longer processing times per chip. In order to circumvent these production bottlenecks during the laser process, further laser machines have been purchased to date. This results in significant financial drawbacks.

The object of the present invention is to eliminate or reduce the drawbacks listed above and to provide a method and an arrangement for this method which permit a greater throughput of memory chips wished to be repaired than the prior art, simultaneously resulting in further advantages.

This object is achieved by virtue of the inventive method comprising the following method steps:
a) photoresist is applied to at least one wafer which is to be repaired;
b) a mask is created in line with the chip-specific fuse coordinates; and
c) the at least one wafer provided with photoresist is exposed using an exposure means through the mask;
   and by virtue of the inventive arrangement comprising an application unit for photoresist onto wafers which are to be repaired, a controllable mask and an exposure means.

Advantageous developments of the invention are presented in the subclaims.

The present invention is based on the idea of replacing the laser fuse process with process steps which are actually needed in order to produce the rest of the circuit features on the chip, that is to say are actually part of the existing production. This largely avoids purchasing costs for new equipment, and hardly any additional space requirement arises in the clean room.

The fuses are broken using an additional conventional etching process. Etching processes are always applied simultaneously to complete wafers or even to a plurality of wafers. This allows such a process step to be performed with optimum throughput (parallelism).

An etching process always requires prior resist coating and exposure. The resist coating, like the etching process, is a procedure which is applied to the whole wafer. In this case, too, it is therefore conceivable to optimize throughput.

The exposure itself now represents a fundamental update and the main part of the invention as a replacement for the laser process. Any exposure requires an exposure mask which is used to prescribe the feature which is to be exposed and etched. To date, this has been done using prefabricated rigid masks, since the process step did not change for a particular product. However, these process steps did not relate to the repair of memory chips, but rather only to the creating thereof. To etch through particular fuses, whose coordinates change on a chip-specific basis as a result of the current fault picture for each chip, the invention therefore provides a controllable mask.

A controllable mask of this type may be provided using a modern, computer-controlled LCD mask. This LCD mask is incorporated into an appropriate exposure machine. The exposure itself can always take place for a plurality of chips (for example eight) in parallel, the exposure times corresponding to those for known lithography methods and being in the order of several milliseconds. It is likewise possible to optimize throughput in this case.

The greatest advantage of this method is the achievable feature size of the fuses and fuse banks, however. They may thus be approximately at the same level as the feature size of the chips' interconnects, which were also achieved using exposure methods. Even the known arrangement of the fuses in rows and banks is no longer necessary. These may be arranged in an arbitrary distribution over the entire chip, merely taking account of the electrical stipulations and the layout techniques. The old stipulations which were used for optimization in the case of laser fuses (short paths from fuse to fuse) may be dispensed with. It is thus possible for the fuses to be distributed over the entire chip in optimized, advantageous and space-saving fashion, which reduces the size of the chip area and decreases production costs.

Further details of the invention are described with reference to the drawing using a schematically illustrated exemplary embodiment.

In the drawing:

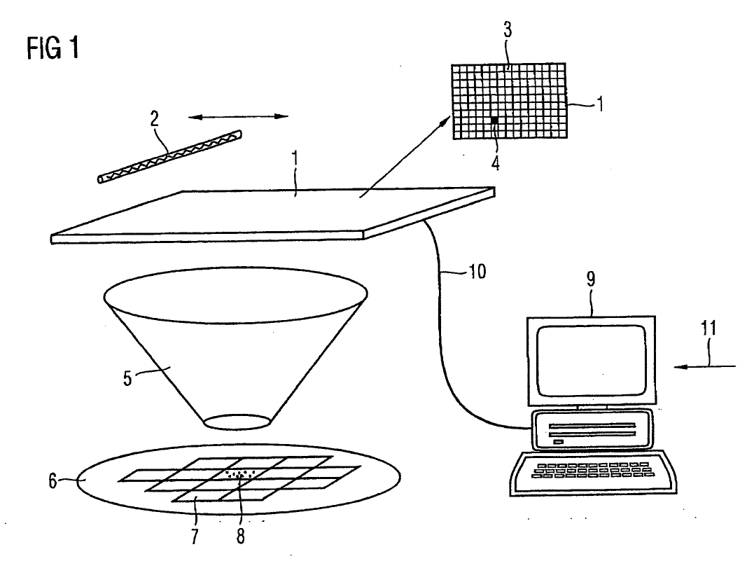

FIG. 1 shows an illustrative inventive arrangement for carrying out a method based on the invention for repairing memory chips using microlithography means.

In FIG. 1, the reference symbol 1 illustrates a mask which is arranged between an exposure means 2 and a wafer 6 with memory chips 7 which is to be exposed.

The mask 1 is advantageously a controllable mask which is preferably in the form of an LCD screen. This LCD screen has a mask grid 3 with pixels 4, which is shown in the top right-hand corner of FIG. 1.

The controllable mask 1 is used to set the chip-specific fuse coordinates.

In the exemplary embodiment shown, the chip-specific fuse coordinates are input using a data input 11 on a control unit 9, which is preferably a computer. The control unit 9 sets the controllable mask 1 using a connection 10. In addition to the chip-specific fuse coordinates, further chip features on the controllable mask 1 are set which are not intended to be covered by the exposure process. Further details regarding a controllable mask 1 and an associated control program will not be explained here.

The exposure means 2 is a known exposure means comprising the exposure units which are used for chip production. In one advantageous embodiment, the exposure means is in movable form, which is shown schematically by the double-headed arrow in FIG. 1.

The exposure process requires that the wafer 6 with the memory chips 7 has been coated beforehand with a known photoresist, such as is used for the conventional lithography methods in chip production. This can be done in a coating unit (which is not shown in this case for reasons of clarity), for example, which is situated within the repair station. In addition, however, it is also conceivable for the coating of the wafers which are to be repaired to be carried out on coating units which are arranged at a different location than the chip production process, for example.

The embodiment outlined makes it possible for not just one memory chip 7 but rather a multiplicity of memory chips 7 or a multiplicity of wafers 6 to be handled in the exposure station. It is also conceivable for not just one mask 1 but rather a multiplicity of masks 1 to be arranged in order to allow the throughput of repairable memory chips 7 on wafers 6.

One particular advantage is that the controllable mask 1 is set by the control unit 9 for each new chip feature 8 which is to be repaired.

In one preferred embodiment, a focusing means 5 is arranged between the controllable mask 1 and the wafer 6 which is to be repaired. This focusing means 5 may be in the form of a lens, and in one particular embodiment this focusing means 5 is also in controllable form. The focusing means 5 may likewise be controlled by the control unit 9 or by a separate additional control unit. This achieves advantageous versatility for the inventive arrangement and for the inventive method.

Following the exposure of the wafer 6 with the memory chips 7 which is to be repaired, this wafer is subjected to an etching method in a known manner, with the fuses which are to be removed being etched out. This etching operation may take place within the repair station on an etching unit. However, it is also conceivable in this context for the etching operation to be performed at another location. The same applies to the further handling steps for the wafer 6, which take place after the etching in a known lithography method.

The embodiment outlined makes it possible for the fuses no longer to have to be produced in the known size and compact arrangement on the memory chip 7. They may advantageously be produced in the size of interconnects.

This results in an advantageous reduction in the space taken up by the fuses on the chip surface.

Although the present invention has been described above with reference to a preferred exemplary embodiment, it is not limited thereto, but rather may be modified in a wide variety of ways.

Thus, by way of example, a plurality of exposure means 2 may be arranged in parallel or in a different shape. It is likewise conceivable for the wafer 6 to be in a form in which its height can be adjusted for the purpose of focusing.

List of Reference Symbols

1 mask
2 exposure means
3 mask grid
4 pixel
5 focusing means
6 wafer
7 memory chip
8 chip feature
9 control unit
10 connection
11 data input

1. A method for repairing memory chips with redundant cell areas and corresponding fuses using microlithography means, characterized by the following method steps:
a) applying photoresist to at least one wafer which is to be repaired;
b) creating a mask in line with the chip-specific fuse coordinates which correspond to the repair; and
c) exposing at least one wafer provided with photoresist using an exposure means through the mask.

2. The method as claimed in claim 1, wherein method step b) comprises production of the mask in relation to the following method steps:
b1) inputting the chip-specific fuse coordinates into a control unit; and
b2) using and setting a controllable mask using the control unit.

3. The method as claimed in claim 2, wherein method step b2) involves the use of an LCD screen as controllable mask.

4. The method as claimed in claim 1, wherein the exposure means is in movable form for the exposure in method step c).

5. The method as claimed in claim 1, wherein the focusing during the exposure in method step c) involves the use of a focusing means.

6. The method as claimed in claim 5, wherein the focusing means is in controllable form.

7. An arrangement for a method for repairing memory chips with redundant cell areas and corresponding fuses using microlithography means, wherein the arrangement comprises an application unit for photoresist onto wafers which are to be repaired, a controllable mask and an exposure means.

8. The arrangement as claimed in claim 7, wherein the controllable mask is set using a control unit on the basis of the chip-specific fuse coordinates which correspond to the repair.

9. The arrangement as claimed in claim 8, wherein the controllable mask is an LCD screen.

10. The arrangement as claimed in claim 7, wherein the exposure means is in movable form.

11. The arrangement as claimed in claim 7, wherein a focusing means is arranged between the exposure means and the wafer which is to be repaired.

12. The arrangement as claimed in claim 11, wherein the focusing means is in controllable form.
